(19) United States
(12) Patent Application Publication
(10) Pub. No.: US 2007/0284780 A1
(43) Pub. Date: Dec. 13, 2007

(54) Transfer press apparatus and method for controlling the same

(75) Inventor: Mansuhk Suh, Ulsan (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 11/590,424

(22) Filed: Oct. 30, 2006

(30) Foreign Application Priority Data
Jun. 7, 2006 (KR) 10-2006-0050959

(51) Int. Cl. B29C 57/00

(52) U.S. Cl. 264/294; 425/186; 425/411; 425/436 RM; 264/296

(57) ABSTRACT

A transfer press apparatus for molding a material panel in a predetermined shape is provided, which comprises: (a) an upper mold; (b) a lower mold; (c) a crankshaft to supply power to move the upper and lower molds; (d) a blank holder connected to an outer circumference of the lower molder; (e) a finger arranged between the upper mold and the lower mold so as to lift the panel after the panel is molded by the upper and lower molds; and (f) an operating die face unit mounted on the blank holder so as to provide a space for receiving the finger when the finger is used to lift the panel. A method for controlling the apparatus is also provided.

### CROSS-REFERENCE TO RELATED APPLICATION

This application claims priority to and the benefit of Korean Patent Application No. 10-2006-0050959 filed in the Korean Intellectual Property Office on Jun. 07, 2006, the entire contents of which are incorporated herein by reference.

### BACKGROUND OF THE INVENTION

(a) Field of the Invention

The present invention relates to a transfer press apparatus and a method for controlling the same. More particularly, the present invention relates to a method for controlling the same including an operating die face unit operating to form a space for receiving a finger.

(b) Description

Generally, when a vehicle maker produces a vehicle, about two to three thousand elements are assembled through a number of manufacturing and assembly processes.

Particularly, a vehicle body is manufactured at the first step of a vehicle manufacturing process.

A panel is produced by various kinds of press apparatus, and then the vehicle body is produced as a body in white (BIW). The panel is then moved to a vehicle body factory and the respective parts of the panel are assembled.

As described, in order to form a material panel into a product panel, the material panel should be pressurized and molded by many kinds of press equipments.

FIG. 1, FIG. 2, and FIG. 3 show an operation of a conventional transfer press apparatus, which typically includes a lower mold 3, an upper mold 5, a blank holder 11, and a lifting apparatus 19.

A material panel 1a is provided between the lower mold 3 and the upper mold 5, which is to be molded by pressure applied.

The blank holder 11 is mounted between a bolster 7 and an outer circumference of the lower mold 3 through a cushion spring 9.

The lifting apparatus 19 is mounted on the blank holder 11, which is to lift the product panel 1b such that a finger 15 can load the product panel 1b after molding by a molding surface 13 is accomplished.

Pressing pins 21 are mounted to the lower portion of the upper mold 5 such that the pressing pins 21 coercively push the lifting apparatus 19 when the upper mold 5 moves down.

Referring to FIG. 4, the lifting apparatus 19 separates the molded product panel 1b from a pressing surface 17 of the lower mold 3 after the upper mold 5 molds the product panel 1b.

And then, the lifting apparatus 19 lifts the product panel 1b such that the finger 15 forwards the product panel 1b to the next process.

The lifting apparatus 19 has a lifting block therein. A part of the upper side of the lifting block 103 is formed as a pressing surface 101 corresponding to the upper mold 5.

In addition, the lifting block 103 is arranged to receive an elastic force in an upright direction from a return spring 105.

A stopper 109 is mounted to one side of the blank holder 11 to limit the elastic force through a stopper groove 107 formed to the outer circumference of the lifting block 103.

A wear plate 11 is interposed between the blank holder 11 and the lifting block 103 in a vertical direction to help the sliding operation.

Therefore, as shown in FIG. 1, if the material panel 1a is inserted between the lower mold 3 and the upper mold 5, and then the upper mold 5 moves down, the pressing pins 21 will press the lifting block 103 so as to be aligned with the pressing surface 17 of the lower mold 3.

Simultaneously, as shown in FIG. 2, the upper mold 5 molds the material panel 1a into the product panel 1b.

And then, if the upper mold 5 moves up, the lifting block 103 moves up by the return spring 105.

Therefore, the lifting block 103 lifts the molded product panel 1b to the stopper 109 while supporting edges of the product panel 1b such that the finger 15 can load the product panel 1b.

However, according to the prior art, when the lifting apparatus lifts the molded panel, the product panel can bounce and deviate from a predetermined position because the elastic force of the return spring 105 suddenly applies, as shown in FIG. 4. As a result, the finger 15 having a fixed moving track cannot load the product panel 1b appropriately.

Moreover, a position where the pressing pin 21 pushes the lifting block 103 cannot fit the center point of operating. Consequently, referring to portion A in FIG. 4, scratches can be made on the wear plate 111, a sliding surface of the lifting block. These scratches in turn can shorten the lifespan of the molds.

There is thus a need for a transfer press that can produce a mold product with reduced breakage and scratches and improved durability.

The above information disclosed in this Background of the Invention section is only for enhancement of understanding of the background of the invention and should not be taken as an acknowledgement or any form of suggestion that this information forms the prior art that is already known to a person of ordinary skills in the art.

### SUMMARY OF THE INVENTION

In one aspect, a transfer press apparatus for molding a material panel in a predetermined shape is provided, which comprises: (a) an upper mold; (b) a lower mold; (c) a crankshaft to supply power to move the upper and lower molds; (d) a blank holder connected to an outer circumference of the lower molder; (e) a finger arranged between the upper mold and the lower mold so as to lift the panel after the panel is molded by the upper and lower molds; and (f) an operating die face unit mounted on the blank holder so as to provide a space for receiving the finger when the finger is used to lift the panel.

In another aspect, the present invention provides a transfer press apparatus for molding a material panel in a predetermined shape, which comprises: (a) an upper mold; (b) a lower mold; (c) a crankshaft to supply power to move the upper and lower molds; (d) a blank holder connected to an outer circumference of the lower molder; (e) a finger arranged between the upper mold and the lower mold so as to lift the panel after the panel is molded by the upper and lower molds; and (f) an operating die face unit comprising: (i) a die face block slidably mounted on the blank holder and forming a space for receiving the finger when the finger is used to lift the panel; (ii) an actuator connected to a fixed block upwardly extending from the blank holder so as to move the die face block horizontally on the blank holder; (iii) an air compressor connected with the actuator by at least one air pressure passage; (iv) a first sensor mounted to a pressing surface of the lower mold to detect position of the panel; (v) second and third sensors mounted to the blank holder to detect positions of the die face block; (vi) a fourth sensor mounted to the finger to detect position of the panel loaded to the finger; (vii) a crank angle sensor mounted to the crankshaft to detect an angle of the crankshaft; (viii) a-solenoid valve mounted to at least one air pressure passage; and (ix) a controller to open and close the solenoid valve in response to signals from the first, second, third, and fourth sensors, and the crank angle sensor.

In still another aspect, a method for controlling the transfer press apparatus is provided comprising the steps of: (a) inserting a material panel between a lower mold and an upper mold; (b) moving the upper mold down; (c) supporting the panel by moving forward a die face block when a crankshaft angle is in a first predetermined range; (d) molding the panel by uniting the upper mold with the lower mold; (e) moving the upper mold up; (f) forming a finger inserting space under the molded panel by moving the die face block backward when a crankshaft angle is in a second predetermined range; (g) loading the molded panel to the finger from the lower mold by inserting the finger into the finger inserting space; and (h) forwarding the molded panel to the next process.

In a further aspect, motor vehicles are provided that comprise a panel prepared by a described apparatus or method.

It is understood that the term “vehicle” or other similar term as used herein is inclusive of motor vehicles in general such as passenger automobiles, buses, trucks, various commercial vehicles, and the like.

Other aspects of the invention are discussed infra.

### BRIEF DESCRIPTION OF THE DRAWINGS

FIG. 1 to FIG. 3 show a respective operational step of a conventional transfer press apparatus. FIG. 4 shows a lifting apparatus for a transfer press according to the prior art. FIG. 5 shows a partial section of a transfer press apparatus according to an exemplary embodiment of the present invention. FIG. 6 and FIG. 7 show operations of moving a transfer press apparatus up and down according to an exemplary embodiment of the present invention. FIG. 8 is a diagram showing a relation of an operation of an actuator and an angle of a crankshaft according to an exemplary embodiment of the present invention. FIG. 9 is a block diagram showing an operation of a transfer press apparatus according to an exemplary embodiment of the present invention. FIG. 10 is a flowchart showing steps of an operation of a transfer press apparatus according to an exemplary embodiment of the present invention.

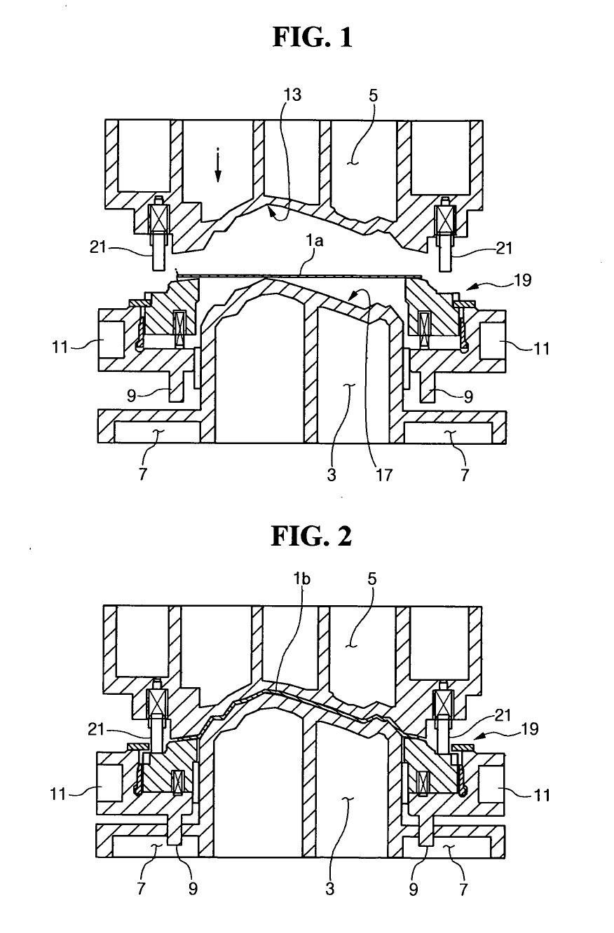

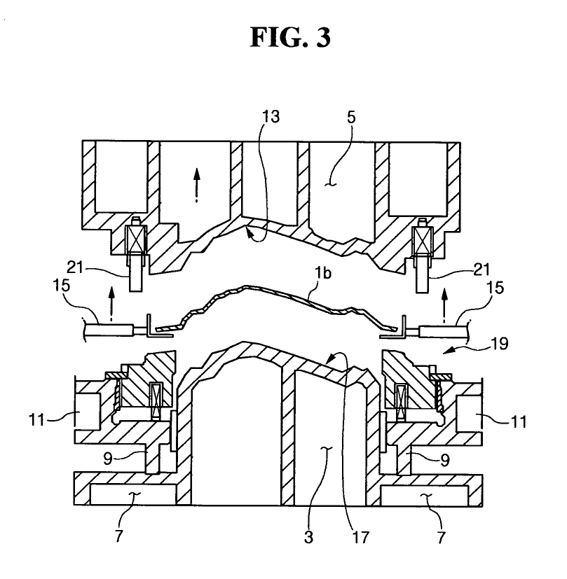

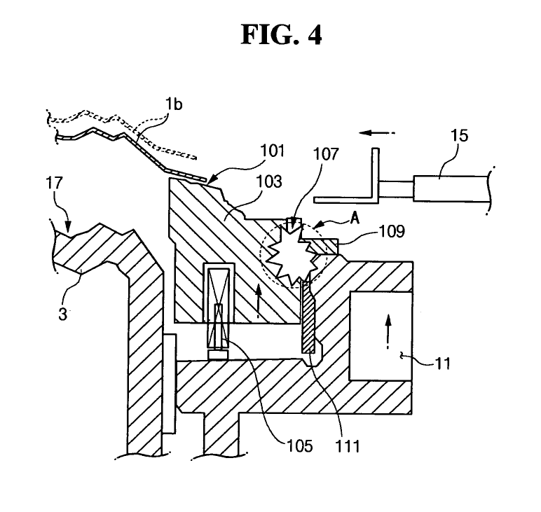

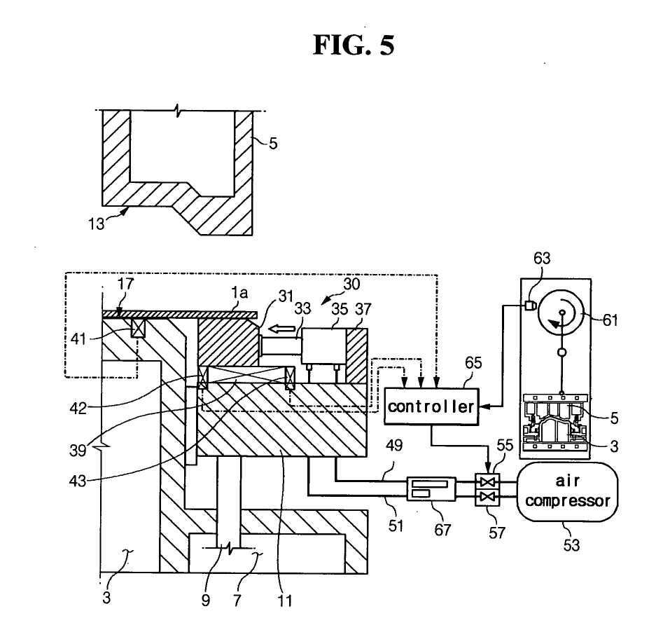

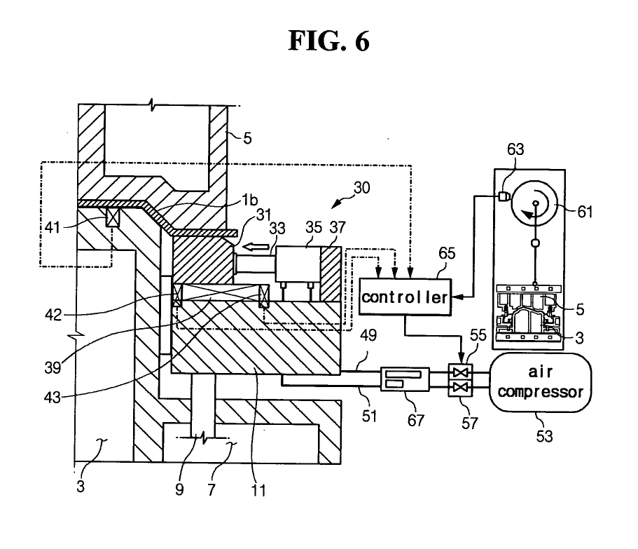

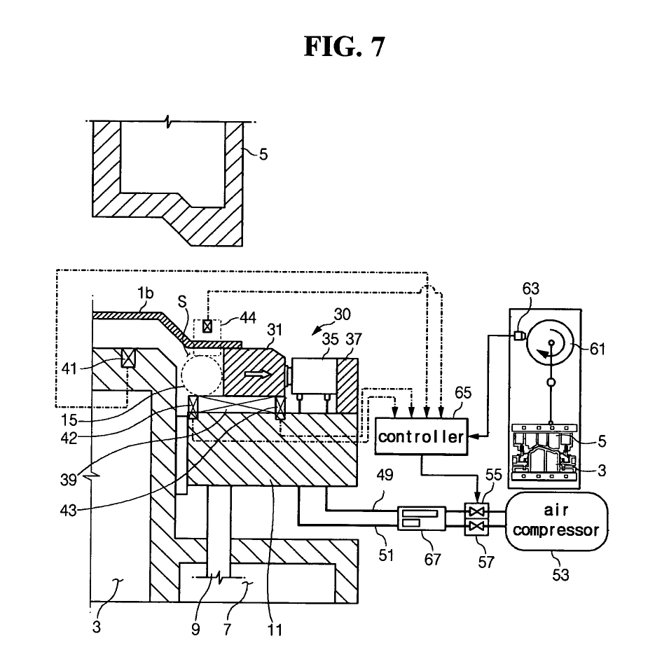

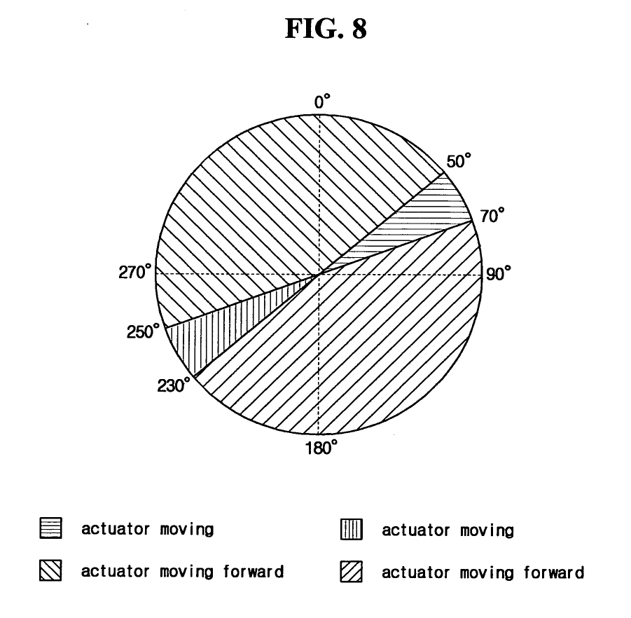

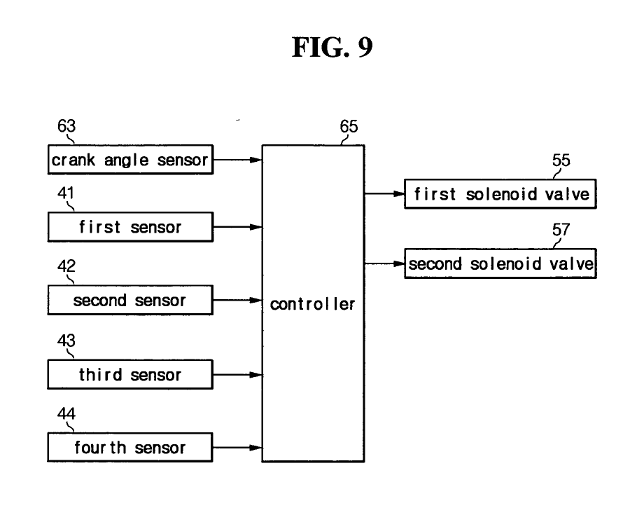

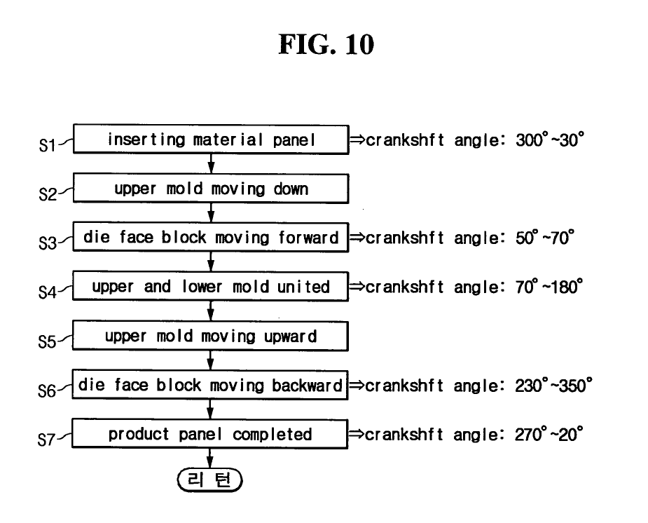

### DETAILED DESCRIPTION

As discussed, in one aspect, the present invention provides a transfer press apparatus for molding a material panel in a predetermined shape, which comprises: (a) an upper mold; (b) a lower mold; (c) a crankshaft to supply power to move the upper and lower molds; (d) a blank holder connected to an outer circumference of the lower molder; (e) a finger arranged between the upper mold and the lower mold so as to lift the panel after the panel is molded by the upper and lower molds; and (f) an operating die face unit mounted on the blank holder so as to provide a space for receiving the finger when the finger is used to lift the panel.

Preferably, an operating die face unit of the present invention comprises (a) a die face block mounted on the blank holder and (b) an actuator connected to a fixed block upwardly extending from the blank holder so that the actuator move the die face block horizontally on the blank holder to provide a space for receiving the finger when the finger is used to lift the panel.

In a preferred embodiment, the die face unit may further comprise an air compressor connected with the actuator by at least one air pressure passage.

Suitably, the die face unit may further comprise a solenoid valve connected to the air pressure passage. To open or close the solenoid valve, a preferred die face unit may further comprise a controller.

Also suitably, the die face unit of the present invention may further comprise a plurality of sensors to detect positions of the panel and/or the die face block. More particularly, for example, the die face unit may comprise: (a) a first sensor disposed on the lower mold to detect position of the panel; (b) second and third sensors disposed on the blank holder to detect positions of the die face block; (c) a fourth sensor disposed on the finger to detect position of the panel loaded to the finger; and (d) a crank angle sensor disposed on the crankshaft to detect a crankshaft angle.

In another aspect, a transfer press apparatus for molding a material panel in a predetermined shape is provided, which comprises: (a) an upper mold; (b) a lower mold; (c) a crankshaft to supply power to move the upper and lower molds; (d) a blank holder connected to an outer circumference of the lower molder; (e) a finger arranged between the upper mold and the lower mold so as to lift the panel after the panel is molded by the upper and lower molds; and (f) an operating die face unit comprising: (i) a die face block slidably mounted on the blank holder and forming a space for receiving the finger when the finger is used to lift the panel; (ii) an actuator connected to a fixed block upwardly extending from the blank holder so as to move the die face block horizontally on the blank holder; (iii) an air compressor connected with the actuator by at least one air pressure passage; (iv) a first sensor mounted to a pressing surface of the lower mold to detect position of the panel; (v) second and third sensors mounted to the blank holder to detect positions of the die face block; (vi) a fourth sensor mounted to the finger to detect position of the panel loaded to the finger; (vii) a crank angle sensor mounted to the crankshaft to detect an angle of the crankshaft; (viii) a solenoid valve mounted to at least one air pressure passage; and (ix) a controller to open and close the solenoid valve in response to signals input from the first, second, third, and fourth sensors, and the crank angle sensor.

Preferably, the die face block may be slidably mounted on the blank holder in inner and outer directions. Suitably, an upper surface of the die face block can correspond to a lower surface of the upper mold.

Also preferably, the actuator may be connected to the die face block by a rod, and an end portion of the rod may be secured to a securing block formed to an outside of the blank holder.

A preferred apparatus of the present invention further comprises a sliding plate which is slidably connected to the die face block between the second sensor and the third sensor.

Preferably, another preferred apparatus may further comprise an airflow controller disposed to the at least one air pressure passage to supply to the actuator the air pressure received from the air compressor.

In a preferred embodiment, the actuator may be designed as a double-acting type air pressure cylinder. The first, second, third, and fourth sensors may be designed as close sensors.

In still another aspect, the present invention provides a method for controlling a transfer press apparatus comprising the steps of: (a) inserting a material panel between a lower mold and an upper mold; (b) moving the upper mold down; (c) supporting the panel by moving forward a die face block when a crankshaft angle is in a first predetermined range; (d) molding the panel by uniting the upper mold with the lower mold; (e) moving the upper mold up; (f) forming a finger inserting space under the molded panel by moving the die face block backward when a crankshaft angle is in a second predetermined range; (g) loading the molded panel to the finger from the lower mold by inserting the finger into the finger inserting space; and (h) forwarding the molded panel to the next process.

Preferably, the first predetermined range of crankshaft angle may be from 50° to 70° and the second predetermined range may be from 230° to 250°.

Preferably, in the step (a) where the panel is inserted, the first sensor detects position of the panel and transmits a signal to the controller and the crank angle sensor detects the crankshaft angle and transmits a signal to the controller.

Suitably, the panel may be inserted when the crankshaft angle is in the range from 300° to 30°.

Also suitably, in the step (c) when the die face block is operated to support the panel, the second sensor detects position of the die face block and transmits to the controller a signal to move the die face block forwardly.

In a preferred embodiment, in the step (e) where the upper mold moves up after the molding is finished, the controller may recognize from the signal transmitted by the first sensor that the panel is loaded and may continue receiving the signal from the crank angle sensor.

Preferably, in the step (f) where the finger inserting space is formed, the third sensor may detect position of the die face block and transmit to the controller a signal to move the die face block backwardly.

Also preferably, in the steps (g) and (h) where the panel is forwarded to the next process after the molded panel is loaded to the finger from the lower mold, the fourth sensor may detect position of the panel loaded to the finger and transmit a signal to the controller.

In the steps (g) and (h) where the panel is forwarded to the next process after the molded panel is loaded to the finger from the lower mold, the crankshaft angle may be in the range from 270° to 20°.

Reference will now be made in detail to the preferred embodiment of the present invention, examples of which are illustrated in the drawings attached hereinafter, wherein like reference numerals refer to like elements throughout. The embodiments are described below so as to explain the present invention by referring to the figures.

Referring to FIG. 5 to FIG. 7, a lower mold 3 is disposed to mold a material panel 1a, and an upper mold 5 is disposed over the lower mold 3 to mold a material panel 1a by pressing an upper surface of the material panel 1a.

That is, a lower surface of the upper mold 5 corresponds to the upper surface of the lower mold 3 and the material panel 1a is formed as a product panel 1b through the two surfaces contacting and pressurizing the material panel 1a.

A preferred transfer press apparatus, which includes the upper mold 5, the lower mold 3, and a blank holder 11, for molding a material panel into a predetermined shape by pressure, includes an operating die face unit 30, an air compressor 53, first, second, third, and fourth sensors 41, 42, 43, and 44, a crank angle sensor 63, solenoid valves 55 and 57, and a controller 65.

The operating die face unit 30 is located to the blank holder 11 and includes a die face block 31 forming a space for receiving a finger 15 to lift the material panel 1a and an actuator 35 moving the die face block 31 corresponding to an operation of a crankshaft 61.

The air compressor 53 is connected with the actuator 35 through air pressure passages 49 and 51.

The first sensor 41 is mounted to a pressing surface of the lower mold 3 and detects a panel 1a and 1b, and the second sensor 42 and the third sensor 43 detect position of the die face block 31.

The fourth sensor 44 is mounted to one side of the finger 15 to detect the loaded panel 1b and the crank angle sensor 63 detects an angle of the crankshaft 61.

The solenoid valves 55 and 57 are disposed to the air pressure passages 49 and 51, and open and close the respective air pressure passages 49 and 51.

The controller 65 mounted to the air pressure passages 49 and 51 opens and closes the solenoid valves 55 and 57 corresponding to a signal input from the first, second, third, and fourth sensors 41, 42, 43, and 44 and the crank angle sensor 63.

The blank holder 11 is disposed between an outer circumference of the lower mold 3 and a bolster 7, and is supported by a spring 9.

The operating die face unit 30 is mounted on an upper surface of the blank holder 11 such that the finger 15, which is to lift the product panel 1b from the pressing surface 17 of the lower mold 3 after forming the product panel 1b, may be inserted. The operating die face unit 30 includes the die face block 31 disposed slidably in an inner and outer direction on the blank holder 11.

An upper surface of the die face block 31 defines a face surface corresponding to a lower surface of the upper mold 5.

The actuator 35 is connected to the die face block 31 through an operational rod 33.

In addition, the actuator 35 is mounted to a securing block 37 mounted to an outside of the blank holder 11.

Also, under a lower surface of the die face block 31, a sliding plate 39 is disposed to the blank holder 11 such that the die face block 31 may be slidably connected to the blank holder 11.

The described operating die face unit 30 is disposed to plural places on the blank holder 11 outside of the lower mold 3.

The operating die face unit 30 moves the die face block 31 back and forth in a horizontal direction by utilizing the actuator 35 operating together with the operating cycle of the crankshaft 61.

Therefore, the die face block 31 supports the panel on the lower mold 3 and forms a finger inserting space S.

According to an exemplary embodiment of the present invention, the actuator 35 may be designed as a double-acting type air pressure cylinder utilizing an air pressure as an operating pressure.

On the other hand, the actuator 35 is connected to an air compressor 53 through two air pressure passages 49 and 51.

That is, the actuator 35 receives the air pressure through the air pressure passages 49 and 51.

First and second solenoid valves 55 and 57 are respectively mounted to the two air pressure passages 49 and 51 to open and close the respective air pressure passages 49 and 51.

In addition, the first sensor 41 is mounted to the upper surface of the lower mold 3 to recognize that the panel is stably located on the lower mold 3.

The second and third sensors 42 and 43 are disposed to both ends of the sliding plate 39 to recognize that the die face block 31 moves back and forth.

The fourth sensor 44 is disposed to one side of the finger 15 to detect position of the panel and the crank angle sensor 63 is disposed to one side of the crankshaft 61 to detect a crankshaft angle.

The crankshaft 61 supplies power such that the upper mold 5 moves up and down and the crank angle sensor 63 detects an angle of the crankshaft.

According to an exemplary embodiment of the present invention, the first, second, third, and fourth sensors 41, 42, 43, and 44 may be designed as close sensors.

In addition, the first, second, third, and fourth sensors 41, 42, 43, and 44, and the crank angle sensor 63 are electrically connected with the controller 65.

Therefore, an opening and closing time of the first and second solenoid valves 55 and 57 is controlled in response to signals input from each sensor 41, 42, 43, 44, and 63.

In addition, an air flow controller 67 may be mounted to one side of the two air pressure passages 49 and 51 to regulate and supply the air pressure to the actuator 35.

Referring to FIG. 5 to FIG. 10, an operation of the transfer press apparatus is described hereinafter.

First, as shown in FIG. 5, the material panel 1a is inserted between the lower mold 3 and the upper mold 5 at step S1.

At that time, the first sensor 41 detects the material panel 1a and transmits the corresponding signal to the controller 65 and the crank angle sensor 63 detects the angle of the crankshaft 61 and transmits the corresponding signal to the controller 65.

According to an exemplary embodiment of the present invention, the material panel 1a is inserted when the angle of the crankshaft 61 is in the range from 300° to 30°.

And then, the controller 65 confirms that the material panel 1a is stably loaded and moves the upper mold 5 down by a crank angle signal at step S2.

At that time, where the angle of the crankshaft 61 is in a first predetermined range, the die face block 31 moves forward to support the panel 1a.

A preferred range of the crankshaft angle may be from 50° to 70°.

That is, where the angle of the crankshaft 61 is in the first range, a close signal is transmitted to the second solenoid valve 57 and an open signal is transmitted to the first solenoid valve 55.

Therefore, the air pressure is supplied to the actuator 35 such that the operating rod 33 moves forward.

As a result, the die face block 31 moves forward in a horizontal direction, as the upper mold 5 is moving down such that the material panel 1a may be supported at step S3.

At that time, the second sensor 42 detects the die face block 31 and transmits the corresponding signal to the controller 65.

As described, as shown in FIG. 6, a molding is completed by the upper mold 5 and the lower mold 3 being united together through the upper mold 5 successively moving down at step S4.

At that time, the angle of the crankshaft 61 is in a range of 70° to 180°.

And then, the controller 65 confirms from the signal of the first sensor 41 that the product panel 1b is stably loaded and continues receiving the angle of the crankshaft 61 from the crank angle sensor 63.

And then, although the upper mold 5 moves upward again at step S5, the die face block 31 is in the state to move forward in a range from 180° to 230°.

And then, where the angle of the crankshaft 61 is in a second predetermined range, the die face block 31 moves backward and a space into which the finger 15 is inserted is formed under the product panel 1b.

According to an exemplary embodiment of the present invention, the second range may be realized as 230° to 250°.

That is, if the angle of the crankshaft 61 becomes 230°, as shown in FIG. 7, the controller 65 closes the first solenoid valve 55 and opens the second solenoid valve 57 until an angle of the crankshaft 61 becomes 250°.

Therefore, the air pressure is supplied to a front portion of the actuator 35 and the operating rod 33 moves backward and the upper mold 5 moves upward and the die face block 31 moves backward in an outer direction.

As a result, the finger inserting space S is formed under an edge of the product panel 1b at step S6.

At that time, the third sensor 43 detects the die face block 31 and transmits to the controller 65 a signal to move the die face block 31 backwardly.

And then, the finger 15 is inserted into the finger inserting space S and the product panel 1b is stably unloaded from the lower mold 3.

In addition, when the fourth sensor 44 detects the product panel 1b, the controller 65 moves the product panel 1b to the next process at step S7.

The panel completed by the described molding process is forwarded to the next process when an angle of the crankshaft 61 is in a range from 270° to 20°.

As described above, according to the present invention of the transfer press apparatus, the finger can be stably inserted into the inserting space by the die face block moving forward and backward in a horizontal direction by the actuator.

As a result, breakage and scratches of the molds can be prevented and durability of the mold can be improved.

While this invention has been described in connection with preferred embodiments thereof, it is to be understood that changes may be made in these embodiments without departing from the principles and spirit of the invention, the scope of which is defined in the appended claims and their equivalents.

1. A transfer press apparatus for molding a material panel in a predetermined shape, the transfer press apparatus comprising:
(a) an upper mold;
(b) a lower mold;
(c) a crankshaft to supply power to move the upper and lower molds;
(d) a blank holder connected to an outer circumference of the lower molder;
(e) a finger arranged between the upper mold and the lower mold so as to lift the panel after the panel is molded by the upper and lower molds; and
(f) an operating die face unit comprising: (i) a die face block slidably mounted on the blank holder and forming a space for receiving the finger when the finger is used to lift the panel; (ii) an actuator connected to a fixed block upwardly extending from the blank holder so as to move the die face block horizontally on the blank holder; (iii) an air compressor connected with the actuator by at least one air pressure passage; (iv) a first sensor mounted to a pressing surface of the lower mold to detect position of the panel; (v) second and third sensors mounted to the blank holder to detect positions of the die face block; (vi) a fourth sensor mounted to the finger to detect position of the panel loaded to the finger; (vii) a crank angle sensor mounted to the crankshaft to detect an angle of the crankshaft; (viii) a solenoid valve mounted to at least one air pressure passage; and (ix) a controller to open and close the solenoid valve in response to signals input from the first, second, third, and fourth sensors, and the crank angle sensor.

2. The apparatus of claim 1, wherein the die face block is slidably mounted on the blank holder in inner and outer directions, and an upper surface of the die face block corresponds to a lower surface of the upper mold; and the actuator is connected to the die face block by a rod, and an end portion of the rod is secured to a securing block formed to an outside of the blank holder.

3. The apparatus of claim 2, wherein the operating die face unit further comprises a sliding plate slidably connected to the die face block between the second sensor and the third sensor.

4. The apparatus of claim 1, further comprising an air flow controller disposed to the at least one air pressure passage to supply to the actuator the air pressure received from the air compressor.

5. The apparatus of claim 1, wherein the actuator is designed as a double-acting type air pressure cylinder.

6. The apparatus of claim 1, wherein the first, second, third, and fourth sensors are designed as close sensors.

7. A method for controlling a transfer press apparatus comprising the steps of:
(a) inserting a material panel between a lower mold and an upper mold;
(b) moving the upper mold down;
(c) supporting the panel by moving forward a die face block when a crankshaft angle is in a first predetermined range;
(d) molding the panel by uniting the upper mold with the lower mold;
(e) moving the upper mold up;
(f) forming a finger inserting space under the molded panel by moving the die face block backward when a crankshaft angle is in a second predetermined range;
(g) loading the molded panel to the finger from the lower mold by inserting the finger into the finger inserting space; and
(h) forwarding the molded panel to the next process.

8. The method of claim 7, wherein the first predetermined range of crankshaft angle is from 50° to 70° and the second predetermined range is from 230° to 250°.

9. The method of claim 7, wherein when the panel is inserted, the first sensor detects position of the panel and transmits a signal to the controller and the crank angle sensor detects the crankshaft angle and transmits a signal to the controller.

10. The method of claim 7, wherein the panel is inserted when the crankshaft angle is in the range from 300° to 30°.

11. The method of claim 7, wherein when the die face block is operated to support the panel, the second sensor detects position of the die face block and transmits to the controller a signal to move the die face block forwardly.

12. The method of claim 7, wherein when the upper mold moves up after the molding is finished, the controller recognizes from the signal transmitted by the first sensor that the panel is loaded and continues receiving the signal from the crank angle sensor.

13. The method of claim 7, wherein when the finger inserting space is formed, the third sensor detects position of the die face block and transmits to the controller a signal to move the die face block backwardly.

14. The method of claim 7, wherein when the panel is forwarded to the next process after the molded panel is loaded to the finger from the lower mold, the fourth sensor detects position of the panel loaded to the finger and transmits a signal to the controller.

15. The method of claim 7, wherein when the panel is forwarded to the next process after the molded panel is loaded to the finger from the lower mold, the crankshaft angle is in the range from 270° to 20°.

16. A transfer press apparatus for molding a material panel in a predetermined shape, the transfer press apparatus comprising:
(a) an upper mold;
(b) a lower mold;
(c) a crankshaft to supply power to move the upper and lower molds;
(d) a blank holder connected to an outer circumference of the lower molder;
(e) a finger arranged between the upper mold and the lower mold so as to lift the panel after the panel is molded by the upper and lower molds; and
(f) an operating die face unit mounted on the blank holder so as to provide a space for receiving the finger when the finger is used to lift the panel.

17. The apparatus of claim 16, wherein the operating die face unit comprises (a) a die face block mounted on the blank holder and (b) an actuator connected to a fixed block upwardly extending from the blank holder so that the actuator move the die face block horizontally on the blank holder to provide a space for receiving the finger when the finger is used to lift the panel.

18. The apparatus of claim 17, wherein the die face unit further comprises an air compressor connected to the actuator by at least one air pressure passage.

19. The apparatus of claim 18, wherein the die face unit further comprises a solenoid valve connected to the air pressure passage.

20. The apparatus of claim 19, wherein the die face unit further comprises a controller to open or close the solenoid valve.

21. The apparatus of claim 20, wherein the die face unit further comprises a plurality of sensors to detect positions of the panel and/or the die face block.

22. The apparatus of claim 20, wherein the die face unit further comprises (a) a first sensor disposed on the lower mold to detect position of the panel; (b) second and third sensors disposed on the blank holder to detect positions of the die face block; (c) a fourth sensor disposed on the finger to detect position of the panel loaded to the finger; and (d) a crank angle sensor disposed on the crankshaft to detect a crankshaft angle.

23. A vehicle comprising a panel prepared by using the apparatus of claim 1.

24. A vehicle comprising a panel prepared by using the method of claim 7.
